(19) United States
(12) Patent Application Publication
(10) Pub. No.: US 2025/0258705 A1
(43) Pub. Date: Aug. 14, 2025

(54) WORKLOAD CONTROL DEVICE AND WORKLOAD CONTROL METHOD

(71) Applicant: Hitachi, Ltd., Tokyo (JP)

(72) Inventors: Atsuya KUMAGAI, Tokyo (JP); Yoji OZAWA, Tokyo (JP); Hiro TANAKA, Tokyo (JP)

(21) Appl. No.: 19/049,390

(22) Filed: Feb. 10, 2025

(30) Foreign Application Priority Data
Feb. 13, 2024 (JP) 2024-019461

(51) Int. Cl. G06F 9/48; G06F 1/3296

(52) U.S. Cl. CPC G06F 9/4893; G06F 1/3296

(57) ABSTRACT

A workload control device stores: workload management information for managing an execution schedule and power consumption of the workloads constituting the pipeline; and reduced power consumption management information for managing information about power consumption that needs to be reduced from scheduled power consumption and indicative of a reduction period and amount of power consumption. Based on the workload management information and the reduced power consumption management information, the workload control device: determines a priority of a workload to be determined whether to be interrupted; provides a workload scheduled to be terminated by the start of the reduction period with a priority higher than that of a workload scheduled to be terminated after the start of the reduction period; and determines an execution method of the workloads in the order of the priority until the total of the power consumption of the determined workloads reach the reduced amount in the pipeline.

### CLAIM OF PRIORITY

The present application claims priority from Japanese patent application JP 2024-019461 filed on Feb. 13, 2024, the content of which is hereby incorporated by reference into this application.

### BACKGROUND

The present invention relates to a device and a method for controlling execution of a workload.

Power consumption accompanying execution of a workload such as machine learning is increasing, and it is a problem to reduce CO₂ emissions accompanying the power consumption. Although the CO₂ emissions can be reduced by utilizing a renewable energy (renewable energy) such as solar light and wind, the supply of the renewable energy changes temporally, and therefore a technology of scheduling execution of the workload adaptively to the renewable energy supply is studied.

When the renewable energy supply is reduced, there may be assumed a processing of interrupting the execution of the workload, and there is also a technology of generating a checkpoint so as to be able to restart later from the time point of interruption.

On the other hand, an electric power company may request for increase/decrease of power consumption to consumers by a demand response (DR) for a stable supply of electric power, and the consumers responsive to the DR can receive a value for it. The DRs include an up DR requesting for increase of the power consumption and a down DR requesting for decrease of the power consumption. Moreover, the power generated by the DR is not only purchased by the electric power company but also traded in a market, which market is referred to as a negawatt market.

### SUMMARY

When scheduling the workloads, if consumable power for a workload is decreased, the workload cannot be executed as expected. For example, it is general in machine learning that a pipeline processing including a plurality of workloads is performed and that a completion time limit is set to the pipelines. However, it is a problem whether the time limit for the pipeline can be kept if the execution of the workload is stopped.

An aspect of the present invention is a workload control device that controls execution of a pipeline including one or more workloads to be executed sequentially, including: one or more processing devices; and one or more storage devices, in which the one or more storage devices store therein: workload management information for managing an execution schedule and a power consumption of the workloads constituting the pipeline; and reduced power consumption management information for managing information about power consumption that needs to be reduced from scheduled power consumption and indicative of a reduction period and a reduced amount of the power consumption, and in which the one or more processing devices, based on the workload management information and the reduced power consumption management information: determines a priority of a workload scheduled to be determined whether to be interrupted; provides a workload to be terminated by the start of the reduction period with a priority higher than that of a workload scheduled to be terminated after the start of the reduction period; and determines an execution method of the workload in the order of the priority until the total of the power consumption of the determined workloads reach the reduced amount in the pipeline.

According to an aspect of the present invention, it is possible to appropriately control execution of a workload if it is necessary to reduce the power consumption during execution of the workload.

### BRIEF DESCRIPTION OF THE DRAWINGS

FIG. 1 is a system configuration diagram for implementing the present embodiment;

FIG. 2A is a diagram showing an operation of a workload control server;

FIG. 2B is a diagram showing an operation of a workload control server;

FIG. 2C is a diagram showing an operation of a workload control server;

FIG. 2D is a diagram showing an operation of a workload control server;

FIG. 3 is a diagram showing a midway control server;

FIG. 4 is a diagram showing a pipeline management table stored in a storage device of the midway control server;

FIG. 5 is a diagram showing a workload management table stored in the storage device of the midway control server;

FIG. 6 is a diagram showing a power consumption schedule table stored in the storage device of the midway control server;

FIG. 7 is a diagram showing a workload control table stored in the storage device of the midway control server;

FIG. 8 is a diagram showing an allowable emission table stored in the storage device of the midway control server;

FIG. 9 is a diagram showing a DR management table stored in the storage device of the midway control server;

FIG. 10 is a flowchart showing an operation of a midway control program stored in the storage device of the midway control server;

FIG. 11 is a diagram showing a renewable energy reduction table stored in the storage device of the midway control server; and

FIG. 12 is a flowchart showing an operation of a midway control program stored in the storage device of the midway control server.

### DETAILED DESCRIPTION

### First Embodiment

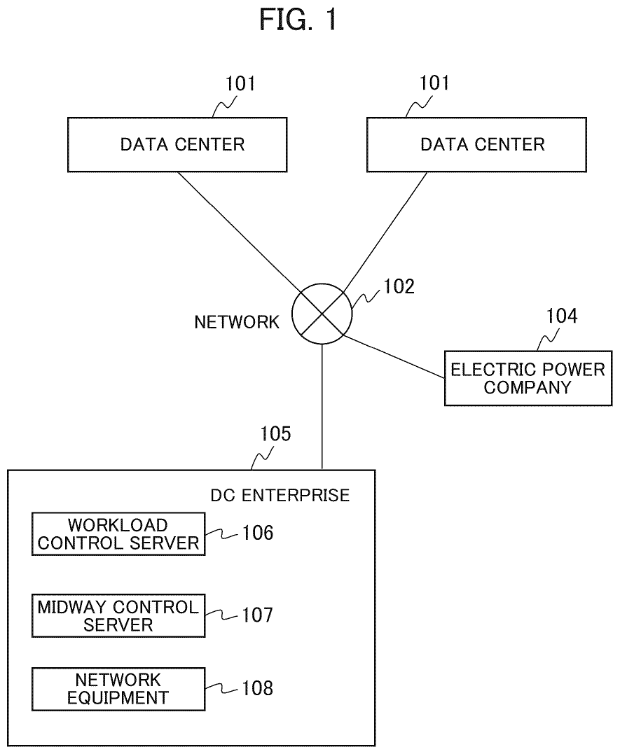

FIG. 1 is a system configuration diagram for implementing an embodiment of the present specification. A system 100 for implementing the present embodiment includes a data center (DC) 101, a network 102, an electric power company 104, and a DC enterprise 105. The DC enterprise 105 has a workload control server 106, a midway control server 107, and network equipment 108. The data center 101 has a server, a storage, network equipment, and the like, and executes a workload entered by the DC enterprise 105. The network 102 is a network such as the Internet.

The workload control server 106 determines the data center 101 and the execution time to execute the workload based on the power consumption and the execution time of the workload and a predicted value of the renewable energy supply of the data center 101. The midway control server 107 is a server that controls interruption and the like of the workload when handling a down DR (Demand Response), an operation of which will be described later. The network equipment 108 is communication equipment such as a switch and a router, and connects the workload control server 106 and the midway control server 107 to the network 102.

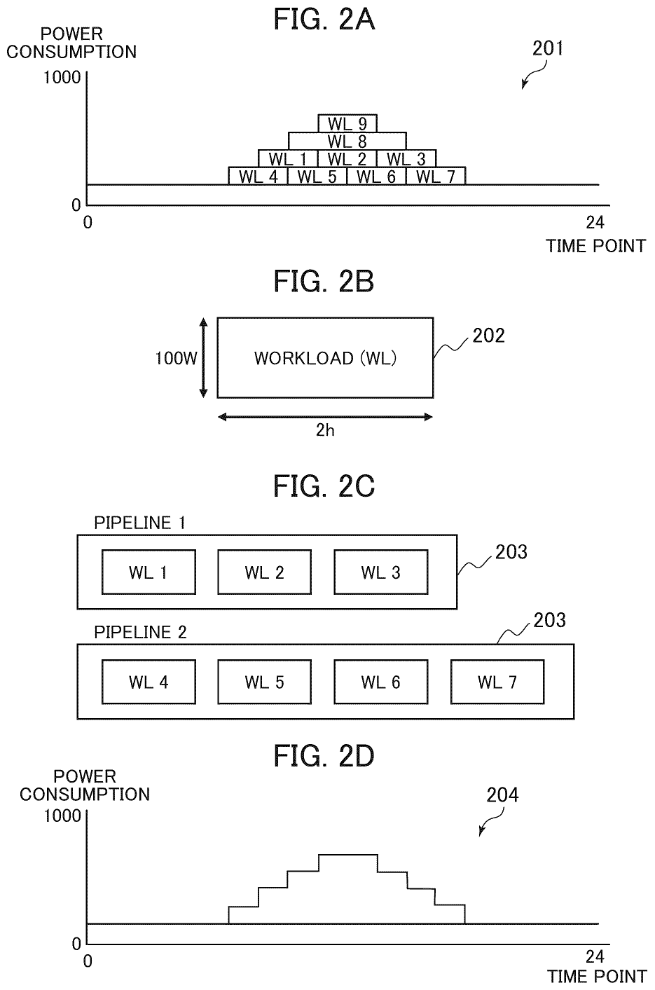

FIGS. 2A to 2D are diagrams for illustrating an operation of the workload control server 106. The operation of the workload control server 106 will be described using a workload schedule 201, a workload 202, and a pipeline 203. A single workload 202 is a unit of processing by a single application, and a single pipeline 203 is constituted by one or more workloads sequentially executed by a single application. The pipeline 203 is used in the field of machine learning, for example. In this specification, one or more sequentially executed workloads are referred to as a pipeline, of which application is not limited.

FIG. 2A shows an example of the workload schedule 201. The horizontal axis of a graph represents time, the vertical axis represents the total power consumption of the workloads, and each rectangle represents a single workload. The workload schedule 201 represents an execution schedule of the workloads based on the power consumption that is managed with respect to each data center 101. The workload schedule 201 represents the workloads 202 to be executed at each time point and their power consumption.

FIG. 2B shows an example of the workload 202. The workload 202 is a processing executed at any of the data centers 101, and has a power consumption and a duration as characteristic values. Each workload is identified by a workload ID and managed using a workload management table 500, of which content will be described later. The example in FIG. 2B shows that the power consumption of the workload 202 is 100 W and the duration is two hours.

FIG. 2C shows an example configuration of the pipeline 203. The pipeline 203 consists of one or more workloads. In the example in FIG. 2, a pipeline 1 consists of workloads WL1, WL2, and WL3. A pipeline 2 consists of workloads WL4 to WL7.

FIG. 2D shows an example of a scheduled power consumption 204. The scheduled power consumption 204 may be configured on the basis of a renewable energy supply prediction. The scheduled power consumption may include, besides the renewable energy, exhaustible energy (non-renewable energy) other than the renewable energy supplied from, for example, a power grid. The workload control server 106 determines the data center 101 to execute the pipeline 203 and a schedule to be executed there based on the scheduled power consumption 204 and the pipeline 203 as well as the workload 202 that constitutes them.

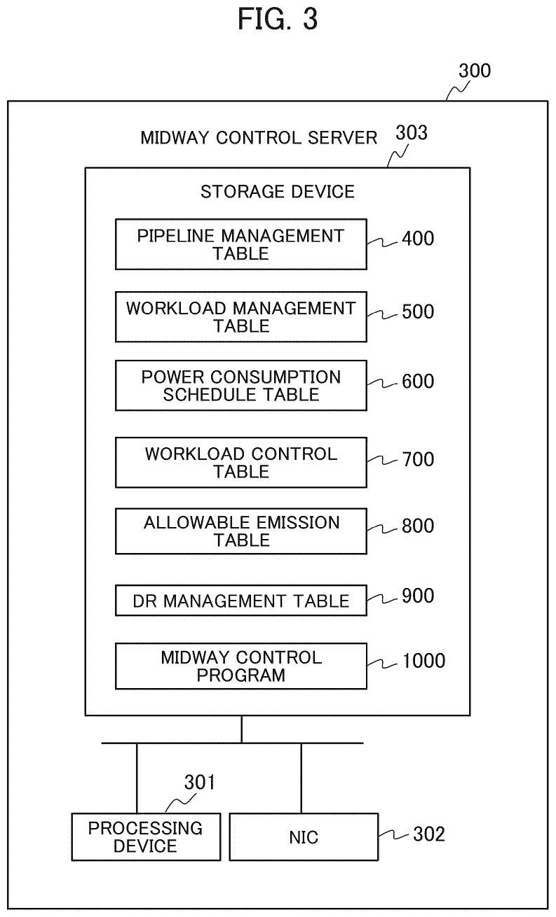

FIG. 3 shows an example configuration of a midway control server 300. The midway control server 300 includes a processing device 301, an NIC 302, and a storage device 303. The processing device 301 is a device such as a CPU, a microprocessor, or the like that reads and executes a program stored in the storage device 303. The processing device 301 can include a plurality of chips and a plurality of packages. The NIC 302 is an interface for accessing the network 102 through connection to the network equipment 108. In addition, the midway control server 300 can include an input device such as a mouse, a keyboard, or the like, and/or an output device such as a display device, a printer, or the like.

The storage device 303 includes a main storage device, and also can include an auxiliary storage device. The main storage device is a volatile storage device such as a DRAM, for example, and the auxiliary storage device may be a nonvolatile storage device such as an SSD (Solid State Drive) or an HDD (Hard Disk Drive), for example. The storage device 303 stores therein a pipeline management table 400, the workload management table 500, a power consumption schedule table 600, a workload control table 700, an allowable emission table 800, a DR management table 900, and a midway control program 1000.

The processing device 301 achieves a predetermined function by executing the program stored in the storage device 303. The storage device 303 stores therein the program to be executed by the processing device 301 and data required for execution of the program. The program performs a specified processing using the storage device 303 and the NIC 302 by being executed by the processing device 301. Therefore, the description herein using the program as a subject may be described using the processing device 301 as the subject. Otherwise, the processing executed by the program is performed by a computer and a computer system on which the program operates.

The processing device 301 operates as a function part (means) for achieving a predetermined function by operating according to a program. For example, the processing device 301 functions as a midway control part (midway control means) by operating according to the midway control program 1000. The computer and the computer system are a device and a system that include the function part.

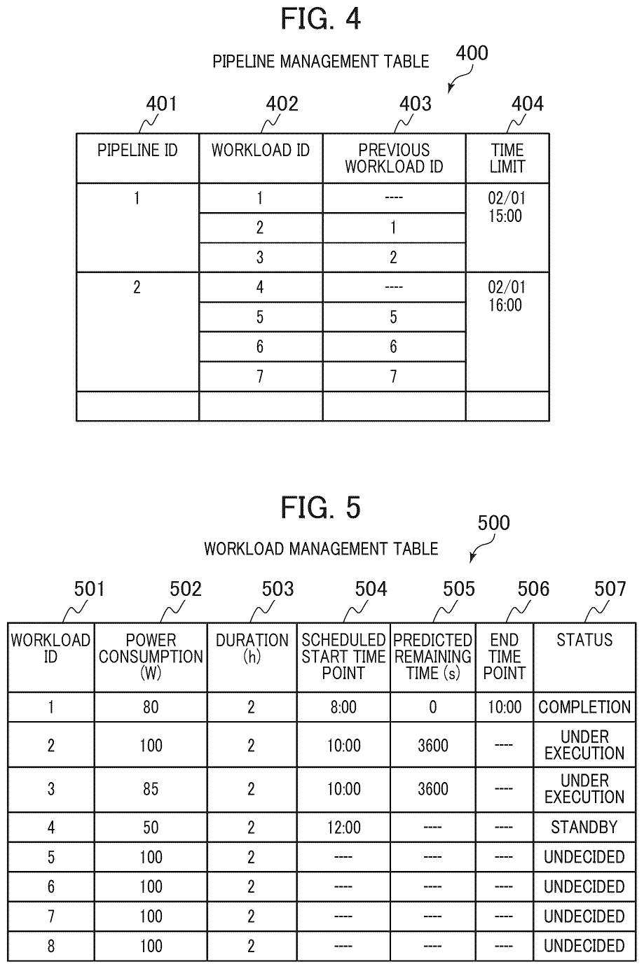

FIG. 4 shows an example configuration of the pipeline management table 400 stored in the storage device 303 of the midway control server 300. The pipeline management table 400 is used to manage information about the pipeline to be executed, and is set by a user before execution of the pipeline, for example. In the example configuration shown in FIG. 4, the pipeline management table 400 includes a pipeline ID 401, a workload ID 402, a previous workload ID 403, and a time limit 404.

The pipeline ID 401 is an identifier for identifying a pipeline. The workload ID 402 is an identifier for identifying a workload that constitutes the pipeline. The previous workload ID 403 is a workload ID of a workload performed immediately before the corresponding workload. The time limit 404 represents a time limit for the corresponding pipeline.

In FIG. 4, for example, it is meant that a pipeline with its pipeline ID being “1” is constituted by workloads with their workload IDs being “1”, “2”, and “3” and that a previous workload of the workload with the workload ID being “2” is the workload with the workload ID being “1”. It is also meant that the time limit for the pipeline with the pipeline ID being “1” is 15:00 on February 1.

FIG. 5 shows an example configuration of the workload management table 500 that is the workload management information stored in the storage device 303 of the midway control server 300. The workload management table 500 is used to manage information about the workloads that constitute the pipeline managed by the pipeline management table 400. The workload management table 500 includes a workload ID 501, a power consumption 502, a duration 503, a scheduled start time point 504, a predicted remaining time 505, and end time point 506, and a status 507.

The workload ID 501 is an identifier for identifying a workload. An ID of each workload indicated by the workload ID 501 matches an ID indicated by the workload ID 402 in the pipeline management table 400. The power consumption 502 is the power consumption of the corresponding workload. The duration 503 is time taken by the corresponding workload. The power consumption 502 and the duration 503 are, for example, set by the user in advance.

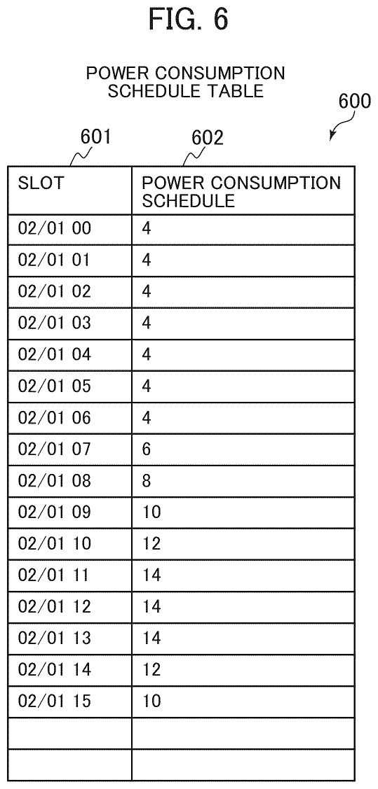

The scheduled start time point 504 is a time point at which the corresponding workload is scheduled to start execution. A value of the scheduled start time point 504 is determined by the workload control server 106. The workload control server 106 can determine the scheduled start time point based on the schedule of the data center power consumption shown in FIG. 6. The workload is scheduled so that the total of the power consumption of the workloads may not exceed the power consumption schedule of each slot. It should be noted that a method of scheduling the workloads is widely known and the details thereof are not described.

The predicted remaining time 505 is a predicted value of the execution time that remains until the corresponding workload is completed. This value is provided by the workload control server 106. A method of predicting the value is widely known and the details thereof are not described. The end time point 506 is a time point at which the corresponding workload is actually terminated.

The status 507 is a status of the corresponding workload. Its initial value is “undecided”. When the scheduled start time point of the workload is registered, the status changes to “standby”. The status further changes to “under execution” when execution of the workload is started, and changes to “completion” when it is terminated.

For example, a record at the top of FIG. 5 means that the power consumption of the workload with the workload ID “1” is 80 W, the duration is two hours, the scheduled start time point is 8:00, the predicted remaining time is 0, the end time point is 10:00, and the status is “completion”.

FIG. 6 shows the power consumption schedule table 600 stored in the storage device 303 of the midway control server 300. The power consumption schedule table 600 is information for managing the renewable energy power consumption of the data center 101, and is determined and registered by an administrator based on the predicted value of the renewable energy supply. The consumed power may include the exhaustible energy other than the renewable energy in addition to the supplied renewable energy.

The power consumption schedule table 600 consists of a slot 601 and a power consumption schedule 602. The slot 601 represents a time zone separated in units of an hour, and “02/01 00” indicates a time zone of 00:00-01:00 February 1. The power consumption schedule 602 represents an amount of power scheduled to be consumed in the corresponding slot (e.g., in units of kWh). In FIG. 6, it is meant that the power consumption schedule for the slot “02/01 00” is “4” and that the power consumption schedule for the slot “02/01 10” is “12”.

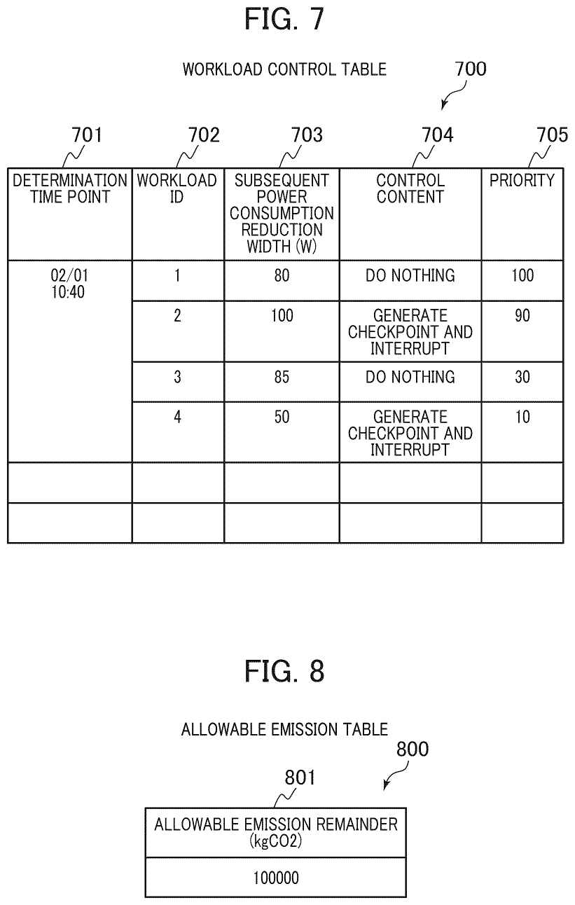

FIG. 7 shows the workload control table 700 stored in the storage device 303 of the midway control server 300. The workload control table 700 is used to manage information about a method of controlling workloads on an event regarding reduction of the power consumption, for example, reduction in renewable energy supply or a received reduction DR request (power consumption reduction request), after the execution schedule for the workload is started.

In the example configuration in FIG. 7, the workload control table 700 includes a determination time point 701, a workload ID 702, a subsequent power consumption reduction width (W) 703, a control content 704, and a priority 705. The determination time point 701 indicates a content of each record, that is, the time point at which the method of controlling the workload is determined. The workload ID 702 indicates an identifier of the workload.

The subsequent power consumption reduction width 703 indicates a reduced amount of the power consumption when the workload is stopped. In this example, the power consumption reduced amount matches the power consumption of the workload. The control content 704 indicates a control content (execution method) determined for each of the workloads. The priority 705 indicates priority of the record of the workload control table 700, that is, execution of the control determined for the workload. Details of the control content and the control content will be described later.

FIG. 8 shows an example configuration of the allowable emission table 800 stored in the storage device 303 of the midway control server 300. The allowable emission table 800 is management information about an allowable emission of carbon dioxide, and consists of an allowable emission remainder 801. The allowable emission remainder 801 indicates a remainder of emission of greenhouse effect gas allowed in a day, for example. The unit may not be a day but a period with another length, and may be directed to one or more types of gas different from carbon dioxide.

The emission allowed in a day is set in advance. The gas emission is calculated by performing a calculation using a predetermined emission factor with respect to an excess consumption of the non-renewable energy from the power consumption schedule at each time point indicated by the power consumption schedule table 600. The allowable emission remainder is calculated by subtracting the above-described gas emission from the current value.

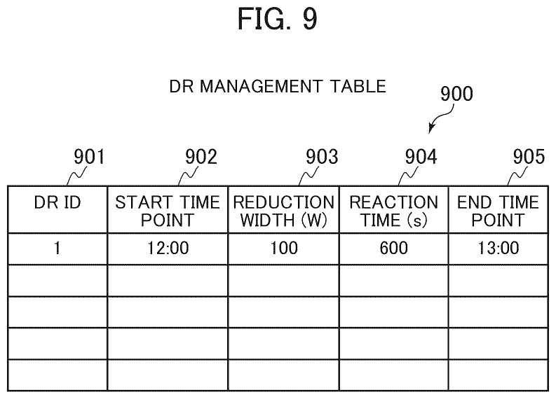

FIG. 9 shows an example configuration of the DR management table 900 stored in the storage device 303 of the midway control server 300. The DR management table 900 is reduced power consumption management information for managing information about the power consumption that needs to be reduced from the scheduled power consumption, and is used to manage a received DR request. In the example configuration shown in FIG. 9, the DR management table 900 includes a DR ID 901, a start time point 902, a reduction width 903, a reaction time 904, and an end time point 905.

The DR ID 901 is an ID for identifying a DR (request). The start time point 902 represents the start time point of the corresponding DR. The reduction width 903 represents a reduction width specified for the corresponding DR. The reaction time 904 represents reaction time specified for the corresponding DR, that is, time from the request to the start time point of the power consumption reduction. The end time point 905 indicates an end time point specified for the corresponding DR, that is, the time point at which the power consumption may increase.

A record at the top of FIG. 9 means that the start time point of the DR with the DR ID “1” is 12:00, the reduction width is 100 W, and the reaction time is 600 seconds. Upon receipt of the electric power company 104 or the DR request from the market, the midway control program 1000 writes the corresponding information to the DR management table 900.

In the example described below, a down DR shall mean a request for supply (consumption) of the renewable energy, that is, reduction of the renewable energy supply. Moreover, the data center shall be able to receive supply of the non-renewable energy from a supply source different from the power supply source from which the request is received. Whether the power from an external supply source is the renewable energy may be determined by, for example, an electric power certificate.

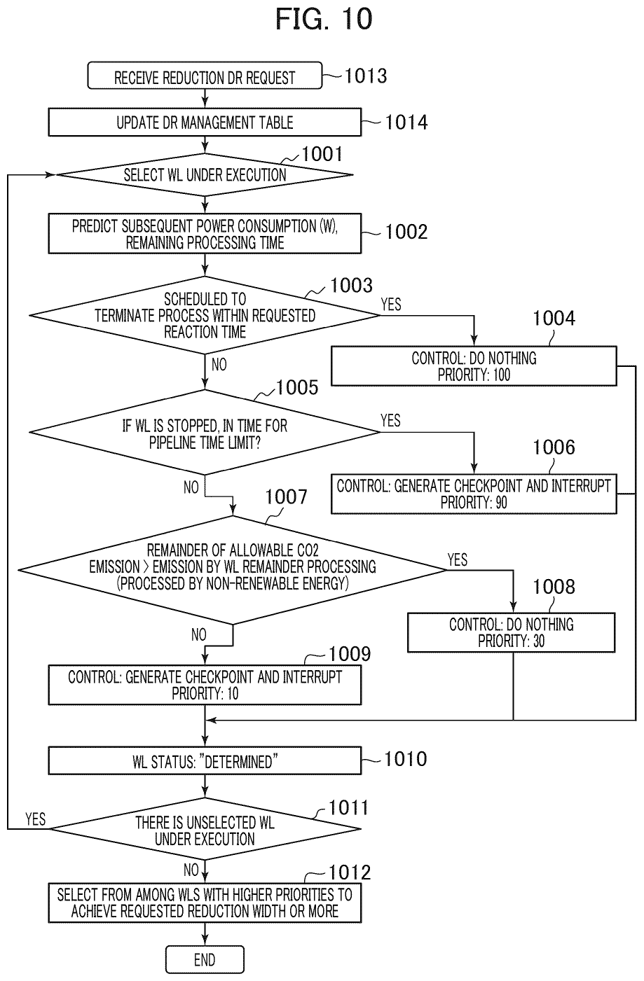

FIG. 10 is a flowchart showing an operation of a midway control program 1000 stored in the storage device 303 of the midway control server 300. The midway control program 1000 updates the DR management table 900 (1014) triggered by receipt of the request for the down DR of the renewable energy (1013). That is, information about the received down DR is registered to a new record of the management table 900.

The midway control program 1000 then selects a workload with the status 507 being “under execution” in the workload management table 500 (1001). The midway control program 1000 performs prediction of the subsequent power consumption reduction width and the remaining processing time from the information in the workload management table 500 on the selected workload (1002). Here, the subsequent power consumption reduction width shall match the value of the power consumption 502 and the remaining processing time shall match the value of the predicted remaining time 505.

The midway control program 1000 compares a value indicated by the reaction time 904 in the DR management table 900 with the above-described remaining processing time, and determines whether the processing of the selected workload within the reaction time (1003). If it is determined that the processing is terminated within the reaction time (1003: YES), the midway control program 1000 updates the control content 704 of the corresponding workload ID in the workload control table 700 to “do nothing” and the priority 705 to “100” (1004). It should be noted that the priority may be represented by any value that can indicate the priority order. This provides the workload scheduled to be terminated within the reaction time (by the start time point) with the priority higher than that of other workloads.

If it is determined that the processing of the selected workload is not terminated within the reaction time (1003: NO), the midway control program 1000 determines whether the corresponding pipeline is terminated within the time limit if the corresponding workload is stopped (1005). The time limit for the pipeline is indicated in the time limit 404 of the pipeline management table 400.

Specifically, the midway control program 1000 obtains information about the pipeline to which the selected workload belongs with reference to the pipeline management table 400. The midway control program 1000 obtains respective durations of the workloads in the scheduled to be executed after the selected workload from the duration 503 of the workload management table 500.

The midway control program 1000 calculates the predicted remaining time when the selected workload under execution is stopped after a specified reaction time has elapsed, and further calculates the predicted remaining time for the pipeline by adding up respective durations of the workloads to be executed. The midway control program 1000 compares the time point having elapsed the predicted remaining time for the pipeline from the end time point of the corresponding DR with the time limit for the corresponding pipeline. The end time point of the DR is indicated by the end time point 905 of the DR management table 900, and the time limit for the pipeline is indicated by the time limit 404 of the pipeline management table 400. From the comparison result, it can be determined whether the corresponding pipeline can be terminated before the time limit.

If it is determined that the corresponding pipeline can be terminated before the time limit, that is, the time limit for the pipeline is retainable (1005: YES), the midway control program 1000 changes the control content 704 of the corresponding workload ID in the workload control table 700 to “generate checkpoint and interrupt” and the priority 705 to “90” (1006).

If it is determined that the corresponding pipeline cannot be terminated before the time limit (1005: NO), the midway control program 1000 compares the CO₂ emissions of the corresponding workload with the remainder of allowable CO₂ emission (1007). The calculation of the CO₂ emissions of the workloads assumes execution of the workloads by the non-renewable energy. The midway control program 1000 calculates the CO₂ emission of the workload from predicted remaining time in the case of executing the workload until the reaction time has elapsed, its power consumption, and a function set in advance. The remainder of the allowable CO₂ emission is shown in the allowable emission table 800.

If the calculated CO₂ emissions of the workload is smaller than the remainder of the allowable CO₂ emission (1007: YES), the midway control program 1000 changes the control content 704 of the corresponding workload ID in the workload control table 700 to “do nothing” and the priority 705 to “30” (1008). This allows for execution of the workload within a range of the allowable CO₂ emissions and the time limit for the pipeline.

If the calculated CO₂ emissions of the workload is not smaller than the remainder of the allowable CO₂ emission (1007: NO), the midway control program 1000 changes the control content 704 of the corresponding workload ID in the workload control table 700 to “generate checkpoint and interrupt” and the priority 705 to “10” (1009). This allows for conforming to the restriction on the allowable CO₂ emissions.

The midway control program 1000 changes the status 507 of the workload processed as described above in the workload management table 500 to “determined” (1010). If there is any other workload of which status 507 is “under execution” in the workload management table 500 (1011: YES), the process returns to Step 1001.

If there is no workload of which status 507 is “under execution” in the workload management table 500 (1011: NO), the midway control program 1000 selects a workload from among workloads with higher priority 705 with reference to the workload control table 700 so as to become equal to or higher than the requested reduction width 903 of the DR (1012). In this manner, the execution method of the workload is determined in the order according to the priority of the priority until the total of the power consumption of the determined workloads reach the reduced amount (requested reduction width). This allows for reducing the CO₂ emissions while suppressing possibility of exceeding the time limit for the pipeline.

The midway control program 1000 can receive the down DR during execution of the workload with the workload ID “2”, for example, and reduce the power consumption thereafter if a control of “generate checkpoint and interrupt” is performed on the workload.

The execution control method for the workload described with reference to FIG. 10 references to several standards in determining the priority of determination order, some of which may be omitted. For example, determination regarding the CO₂ emissions or the pipeline time limit may be omitted, or determination regarding termination of the workload withing the reaction time may be omitted. The same applies to embodiments.

### Second Embodiment

In the first embodiment, the operation of the midway control program 1000 for responding to the reduction DR request is described. As another example, a response to a case in which the renewable energy supply decreases lower than expected can be described in a similar manner. In the present embodiment, a renewable energy reduction table 1100 is used instead of the DR management table 900. In the following, for example, it is assumed that there exists a renewable energy source to the data center that is different from an electric power company or a general power grid. Prediction of the renewable energy supply is performed on the renewable energy supply from the renewable energy source. It is also assumed that the non-renewable energy can be supplied from the electric power company or the power grid due to power shortage.

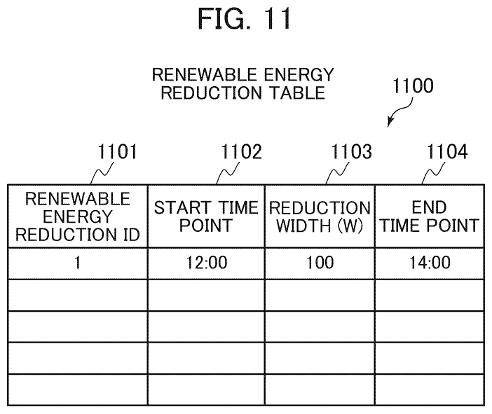

FIG. 11 shows an example configuration of the renewable energy reduction table 1100. The renewable energy reduction table 1100 is reduced power consumption management information for managing information about power consumption that needs to be reduced from scheduled power consumption, and is used to manage the renewable energy supply. The renewable energy reduction table 1100 includes a renewable energy reduction ID 1101, a start time point 1102, a reduction width 1103, and an end time point 1104. The renewable energy reduction ID 1101 indicates an identifier of a predicted renewable energy reduction, that is, an ID of a record in the corresponding table. The start time point 1102 indicates a predicted start time point of the renewable energy reduction. The reduction width 1103 indicates a predicted value of the renewable energy reduction. The end time point 1104 indicates a predicted end time point of the renewable energy reduction.

Various methods are known for predicting the renewable energy supply, and any of the methods may be used. For example, the renewable energy supply can be predicted on the basis of a past history, weather forecast, a measurement about climate information, and the like.

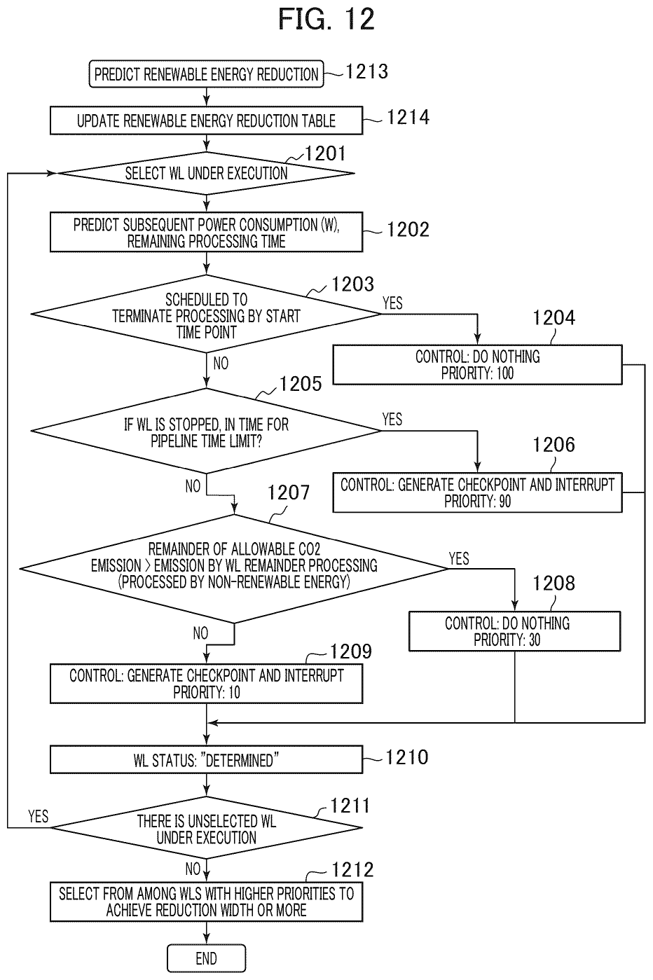

FIG. 12 is a flowchart showing an operation of the midway control program 1000 stored in the storage device 303 of the midway control server 300. The following mainly describes difference from the processing of responding to the request for the down DR shown in FIG. 10. The midway control program 1000 updates the renewable energy reduction table 1100 (1214) triggered by prediction of reduction in the renewable energy supply (1213). The renewable energy supply changes, for example, according to an environmental change. Various techniques are known for predicting reduction in the renewable energy supply, and the details thereof are not described here.

Steps 1201 and 1202 are similar to Steps 1001 and 1002. At Step 1203, the midway control program 1000 compares a value indicated by the start time point 1102 in the renewable energy reduction table 1100 with the remaining processing time of the workload, and determines whether the processing of the selected workload is terminated by the start time point (1203).

If it is determined that the processing is terminated by the renewable energy reduction prediction start time point (1203: YES), the midway control program 1000 updates the control content 704 of the corresponding workload ID in the workload control table 700 to “do nothing” and the priority 705 to “100” (1204). The priority may be represented by any value that can indicate the priority order.

If it is determined that the processing is not terminated by the renewable energy reduction prediction start time point (1203: NO), the midway control program 1000 determines whether the corresponding pipeline is terminated within the time limit if the corresponding workload is stopped (1205). The time limit for the pipeline is indicated in the time limit 404 of the pipeline management table 400.

The midway control program 1000 obtains information about the pipeline to which the selected workload belongs with reference to the pipeline management table 400. The midway control program 1000 obtains respective durations of the workloads in the scheduled to be executed after the selected workload from the duration 503 of the workload management table 500.

The midway control program 1000 calculates the predicted remaining time when the selected workload under execution is stopped from the renewable energy reduction prediction start time point, and further calculates the predicted remaining time for the pipeline by adding up respective durations of the workloads to be executed. The midway control program 1000 compares the time point having elapsed the predicted remaining time for the pipeline from the corresponding renewable energy reduction prediction end time point with the time limit for the corresponding pipeline. The renewable energy reduction prediction end time point is indicated by the end time point 1104 in the renewable energy reduction table 1100, and the time limit for the pipeline is indicated in the time limit 404 of the pipeline management table 400. From the comparison result, it can be determined whether the corresponding pipeline can be terminated before the time limit.

If it is determined that the corresponding pipeline can be terminated before the time limit (1205: YES), the midway control program 1000 changes the control content 704 of the corresponding workload ID in the workload control table 700 to “generate checkpoint and interrupt” and the priority 705 to “90” (1206).

If it is determined that the corresponding pipeline cannot be terminated before the time limit (1205: NO), the midway control program 1000 compares the CO₂ emissions of the corresponding workload with the remainder of allowable CO₂ emission (1207). The calculation of the CO₂ emissions of the workloads assumes execution of the workloads by the non-renewable energy. The midway control program 1000 calculates the CO₂ emission of the workload from the predicted remaining time in the case of executing the workload until the renewable energy reduction prediction start time point, its power consumption, and a function set in advance. The remainder of the allowable CO₂ emission is shown in the allowable emission table 800.

If the calculated CO₂ emissions of the workload is smaller than the remainder of the allowable CO₂ emission (1207: YES), the midway control program 1000 changes the control content 704 of the corresponding workload ID in the workload control table 700 to “do nothing” and the priority 705 to “30” (1208). This allows for execution of the workload within a range of the allowable CO₂ emissions and the time limit for the pipeline.

If the calculated CO₂ emissions of the workload is not smaller than the remainder of the allowable CO₂ emission (1207: NO), the midway control program 1000 changes the control content 704 of the corresponding workload ID in the workload control table 700 to “generate checkpoint and interrupt” and the priority 705 to “10” (1209). This allows for conforming to the restriction on the allowable CO₂ emissions.

The midway control program 1000 changes the status 507 of the workload processed as described above in the workload management table 500 to “determined” (1210). If there is any other workload of which status 507 is “under execution” in the workload management table 500 (1211: YES), the process returns to Step 1201.

If there is no workload of which status 507 is “under execution” in the workload management table 500 (1211: NO), the midway control program 1000 selects a workload from among workloads with higher priority 705 with reference to the workload control table 700 so as to become equal to or higher than the reduction width 1103 of the renewable energy supply (1212). This allows for reducing the CO₂ emissions while suppressing possibility of exceeding the time limit for the pipeline.

### Third Embodiment

In the first embodiment, the priorities for the control set at Steps 1004, 1006, and 1008 are fixed values in the operation of the midway control program 1000 shown in FIG. 10. As another example, the priority can also be set in advance with respect to each user of the pipeline. Each user can request the system to execute one or more pipelines, and further specify the priority of controlling the workload in the pipelines. The present embodiment is also applicable to the second embodiment.

It should be noted that the present invention is not limited to the embodiments described above, and includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiment can be subjected to addition, deletion, and replacement with respect to other configurations.

Moreover, each of the above-described configuration, function, or processing part may be implemented by hardware, for example, by designing a part or all thereof with an integrated circuit. Furthermore, each of the above-described configuration, function, and the like may be implemented by software by a processor interpreting and executing a program that embodies respective functions. Information such as a program, a table, a file, or the like that embodies each function can be placed in a recording device such as a memory, a hard disk, an SSD, and the like or a recording medium such as an IC card, an SD card, and the like.

Moreover, described control lines and information lines are only those supposed to be necessary for explanation, and not all the control lines and information lines used in the product are described. It may be assumed that in fact almost all the configurations are connected to one another.

What is claimed is:

1. A workload control device that controls execution of a pipeline including one or more workloads to be executed sequentially, including:
one or more processing devices; and
one or more storage devices,
wherein the one or more storage devices store therein:
workload management information for managing an execution schedule and a power consumption of the workloads constituting the pipeline; and
reduced power consumption management information for managing information about power consumption that needs to be reduced from scheduled power consumption and indicative of a reduction period and a reduced amount of the power consumption, and
wherein the one or more processing devices, based on the workload management information and the reduced power consumption management information:
determines a priority of a workload to be determined whether to be interrupted and provides a workload scheduled to be terminated by the start of the reduction period with a priority higher than that of a workload scheduled to be terminated after the start of the reduction period; and
determines an execution method of the workload in the order of the priority until the total of the power consumption of the determined workloads reach the reduced amount in the pipeline.

2. The workload control device according to claim 1,
wherein a need for reduction of the power consumption is attributed to a power consumption reduction request from a demand response,
wherein the workload to be terminated by the start of the reduction period is a workload to be terminated within the reaction time of the demand response, and
wherein the determination of the execution method includes determining to retain the execution method of the workload to be terminated within the reaction time of the demand response without change.

3. The workload control device according to claim 1,
wherein, among workloads scheduled to be terminated after the start of the reduction period, a workload capable of retaining a time limit for the pipeline despite an interruption within the reduction period is provided with the priority higher than that of a workload incapable of retaining the time limit for the pipeline due to the interruption within the reduction period, and
wherein the determination of the execution method includes determining to interrupt within the reduction period the workload capable of retaining the time limit for the pipeline despite the interruption within the reduction period.

4. The workload control device according to claim 3, wherein the one or more storage devices store therein management information of an allowable emission of carbon dioxide, and
wherein the determination of the execution method includes determining to execute the workload without interruption if the carbon dioxide emission of the workload incapable of retaining the time limit for the pipeline due to the interruption within the reduction period satisfies a condition of the allowable emission.

5. The workload control device according to claim 1,
wherein the reduced power consumption management information indicates information based on a reduction prediction of a supplied amount of renewable energy.

6. The workload control device according to claim 1,
wherein the determination of the execution method includes determining to retain the workload to be terminated by the start of the reduction period without change.

7. A workload control method performed by a device that controls execution of a pipeline including one or more workloads to be executed sequentially,
wherein the device stores therein:
workload management information for managing an execution schedule and a power consumption of the workloads constituting the pipeline; and
reduced power consumption management information for managing information about power consumption that needs to be reduced from scheduled power consumption and indicative of a reduction period and a reduced amount of the power consumption, and
wherein the workload control method includes, based on the workload management information and the reduced power consumption management information:
determining a priority of a workload to be determined whether to be interrupted and providing a workload to be terminated before the start of the reduction period with a priority higher than that of a workload not to be terminated before the start of the reduction period; and
determining an execution control method of the workload in the order of the priority until the total of the power consumption of the determined workloads reach the reduced amount in the pipeline.
